(19) United States
(12) Patent Application Publication
(10) Pub. No.: US 2006/0152094 A1
(43) Pub. Date: Jul. 13, 2006

(54) Rotor for micro-servomotor, and micro-servomotor equipped with said rotor

(75) Inventors: Shinichiro Mukai, Katakyushu-shi (JP); Shojiro Mori, Katakyushu-shi (JP); Mamoru Era, Katakyushi-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: KABUSHIKI KAISHA YASKAWA DENKI, Kitakyushu-shi (JP)

(21) Appl. No.: 11/375,136

(22) Filed: Mar. 15, 2006

Related U.S. Application Data
(63) Continuation-in-part of application No. PCT/JP04/13352, filed on Sep. 14, 2004.

(30) Foreign Application Priority Data
Sep. 19, 2003 (JP) 2003-328662

(51) Int. Cl. H02K 1/04; H02K 1/22

(52) U.S. Cl. 310/43; 310/261

(57) ABSTRACT

A rotor for a micro-servomotor is reduced in weight and imbalance. The rotor R is provided with a molded resin member 3 having an inclined surface 3a, the resin member 3 being formed by filling an epoxy resin material between the axial end faces of permanent magnets 2 and the external peripheral surface of a shaft 1 made of magnetic material, and also provided with a groove 1b at a part of the external peripheral surface of the shaft 1 opposed to the molded member 3.

This application is a continuation-in-part of a National Stage of International Patent Application No. PCT/JP2004/013352, filed on Sep. 14, 2004. This application claims priority under 35 U.S.C. §119 to Japanese Patent Application No. 2003-328662 filed on Sep. 19, 2003. Each of the entire disclosures of these applications is incorporated herein by reference in its entirety.

### FIELD OF THE INVENTION

The present invention relates to a rotor for a micro-servomotor for use in, e.g., factory automation equipments or precision instruments and a micro-servomotor equipped with such rotor. More specifically, it relates to the structure of the rotor of the micro-servomotor.

### BACKGROUND OF THE INVENTION

The following description sets forth the inventor's knowledge of related art and problems therein and should not be construed as an admission of knowledge in the prior art.

FIG. 3 illustrates a cross-sectional view of a rotor of a conventional micro-servomotor for use in, e.g., factory automation equipments or precision instruments (see, e.g., Japanese Patent No. 3,122,712). This rotor has a shaft 11 with a stepped portion 11a, permanent magnets 12, and a plate 13. In FIG. 3, the reference numeral “E” denotes an edge portion. This rotor is produced in the following manner. That is, a plurality of circular arc shaped divided permanent magnets 12 are axially positioned on the shaft 11 made of magnetic material with the magnets 12 fitted to the stepped portion 11a. With this state, the permanent magnets 12 are made to adhere to the external peripheral surface of the shaft 11 and then a metal plate 13 is made to adhere to the external peripheral surface of the shaft 11 with the metal plate 13 axially positioned. The external diameter of the plate 13 and that of the stepped portion 11a are finished by cutting work so that the plate 13 and the stepped portion 11a have the same diameter after the adhering of the permanent magnets 12 to the shaft 11 to enhance the bonding strength of the permanent magnets 12.

Such a conventional rotor of a micro-servomotor is typically used, for example, at high-speed rotation. However, since the rotor is provided with the metal plate 13 adhering to the permanent magnets 12, there is a drawback that the increased mass reduces the efficiency. Also, in cases where the plate 13 is attached to the shaft 11 in an eccentrically attached manner, the eccentrically attached plate 13 increases the imbalance.

Furthermore, at the time of executing the cutting work to equalize both the external diameters of the plate 13 and the stepped portion 11a in the state in which the permanent magnets 12 adhere to the shaft 11, cracks or breakage may occur at the edge portion E between the permanent magnets 12 and the plate 13 and/or the edge portion E between the permanent magnets 12 and the stepped portion 11a, resulting in reduced strength, which in turn causes increased imbalance.

The description herein of advantages and disadvantages of various features, embodiments, methods, and apparatus disclosed in other publications is in no way intended to limit the present invention. Indeed, certain features of the invention may be capable of overcoming certain disadvantages, while still retaining some or all of the features, embodiments, methods, and apparatus disclosed therein.

### SUMMARY OF THE INVENTION

The preferred embodiments of the present invention have been developed in view of the above-mentioned and/or other problems in the related art. The preferred embodiments of the present invention can improve upon existing methods and/or apparatuses.

Among other potential advantages, some embodiments can provide a rotor for a micro-servomotor that is reduced in weight and imbalance.

According to one aspect of the present invention, a rotor for a micro-servomotor is provided with a stator having a stator coil for forming rotating magnetic field and a rotor comprising a plurality of circular arc shaped permanent magnets attached to an external peripheral surface of a shaft so as to be opposed to the stator via a magnetic gap. The rotor also includes molded resin members that are formed at both sides of the permanent magnets, and each of the molded resin members have an inclined surface formed by filling resin material between axial end faces of the permanent magnets and the external peripheral surface of the shaft.

This rotor has molded resin members each having an inclined surface formed by filling epoxy series resin material between the axial end faces of the permanent magnets and the external peripheral surface of the shaft. Therefore, for example, at the time of finishing the external peripheral surface of the rotor by cutting work in a state in which the permanent magnets adhere to the shaft, it becomes possible to prevent occurrence of cracks and/or breakage of the edge portion between the permanent magnets and the molded resin member.

The shaft may be provided for example, with a groove at a part of the external peripheral surface opposed to one of the formed resin members.

With this rotor, since the groove is formed on the surface of the shaft opposed to one of the molded resin members, the adhesive force along the axial direction can be increased. This also increases the axial adhesive force between the permanent magnets and the formed resin member.

The molded resin member may cover at least edge portions of the axial end faces of the permanent magnets.

The molded resin member may cover entire surfaces of the permanent magnets.

The resin material is, for example, epoxy series resin material.

The shaft, for example, may have a stepped portion and the permanent magnets are axially positioned on the shaft with the permanent magnets fitted to the stepped portion.

An external diameter of the stepped portion may be smaller than an external diameter of the permanent magnet.

According to another aspect of the present invention, a micro-servomotor is equipped with one of the aforementioned rotors.

The above and/or other aspects, features and/or advantages of various embodiments will be further appreciated in view of the following description in conjunction with the accompanying figures. Various embodiments can include and/or exclude different aspects, features and/or advantages where applicable. In addition, various embodiments can combine one or more aspect or feature of other embodiments where applicable. The descriptions of aspects, features and/or advantages of particular embodiments should not be construed as limiting other embodiments or the claims.

### BRIEF DESCRIPTION OF THE DRAWINGS

A preferred embodiment of the present invention is shown by way of example, and not limitation, in the accompanying figures, in which:

FIG. 1 is a cross-sectional view showing a rotor for a micro-servomotor according to an embodiment of the present invention;

FIG. 2 is a front view showing the rotor; and

FIG. 3 is a cross-sectional view showing a conventional rotor for a micro-servomotor.

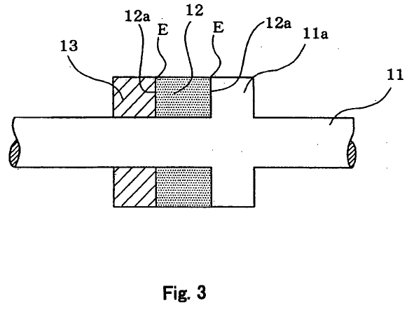

### DETAILED DESCRIPTION OF THE PREFERRED EMBODIMENTS

In the following paragraphs, some embodiments of the invention will be described by way of example and not limitation. It should be understood based on this disclosure that various other modifications can be made by those in the art based on these illustrated embodiments.

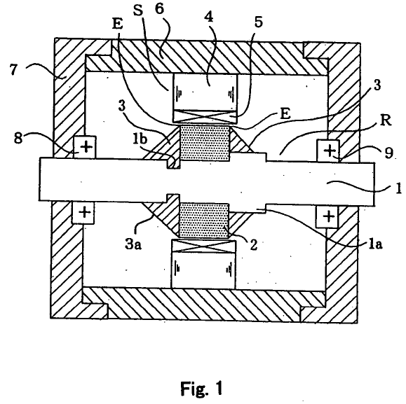

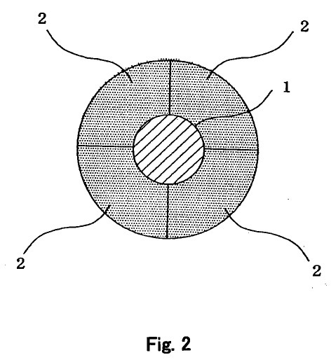

FIG. 1 shows a cross-sectional view of a rotor for a micro-servomotor according to an embodiment of the present invention, and FIG. 2 shows a front view of the rotor.

In FIG. 1, the reference numeral “1” denotes a shaft with a stepped portion 1a and a groove 1b. The reference numeral “2” denotes a magnet, “3” denotes a molded resin member, “4” denotes a stator core, “5” denotes a stator coil, “6” denotes a frame, “7” denotes a bracket, and “8” and “9” denote a shaft bearing respectively, and “E” denotes an edge portion. In this embodiment, the external diameter of the stepped portion 1a is set to be smaller than the external diameter of the permanent magnet 2.

This micro-servomotor has a stator S in which a stator coil 5 for creating rotating magnetic field is wound on the stator core 4 fixed to the frame 6, and a rotor R comprising a plurality of circular arc shaped permanent magnets 2 attached to the external peripheral surface of the shaft 1 and disposed opposed to the stator core 4 via a magnetic gap. The shaft 1 is supported by the shaft bearings 8 and 9 provided at both ends of the frame 6.

The rotor R is provided with molded resin members 3 and 3 each having an inclined surface 3a formed by filling an epoxy series resin material between the axial end faces of the permanent magnets 2 and the external peripheral surface of the shaft 1 of magnetic material, and also provided with a groove 1b formed in the shaft 1 at the portion opposed to one of the molded resin members 3.

Now, the production method of the rotor of the micro-servomotor will be explained.

As shown in FIGS. 1 and 2, for example, four pieces of divided permanent magnets 2 are adhered to the shaft 1 in a state in which the magnets 2 are axially positioned on the external peripheral surface of the shaft 1 with the magnets 2 fitted to the stepped portion 1a, thereby forming a cylindrical shape.

Thereafter, cold setting epoxy series resin material relatively high in viscosity is filled between the edge portions E of both the axial end faces of the permanent magnets 2 and the external surface of the shaft 1 so that a molded resin member 3 with an inclined surface 3a is formed at both ends of the magnets 2. The molded resin material 3 should be formed such that the molded resin material 3 covers at least the edge portions E of the permanent magnets 2 or covers the entire external peripheral surfaces of the permanent magnets 2. The molded resin material 3 can be formed using an injection molding machine together with metal molds.

After the hardening of the resin of the molded resin member 3, cutting work is executed, e.g. by using a grinding stone (not shown), so that the external diameter of the permanent magnet 2 has a predetermined diameter. At this time, since the edge portion E of the permanent magnet 2 is completely covered with the molded resin member 3, occurrence of cracks and/or breakage of the edge portion E due to the cutting work can be prevented. Lastly, the finished external peripheral surfaces of the permanent magnets 2 are subjected for example, to an anti-rust treatment to finish the production of the rotor for the micro-servomotor.

As explained above, in the aforementioned embodiment, the rotor R has molded resin members 3 each having an inclined surface 3a formed by filling epoxy series resin material between the axial end faces of the permanent magnets 2 and the external peripheral surface of the shaft 1. Therefore, at the time of finishing the external peripheral surface of the rotor R by cutting work in a state in which the permanent magnets 2 adhere to the shaft 1, it becomes possible to prevent occurrence of cracks and/or breakage of the edge portion E between the permanent magnets 2 and the molded resin member 3. Furthermore, since the external diameter of the stepped portion 1a of the shaft 1 is smaller than the external diameter of the permanent magnet 2, strength problems would not occur. This also enables the weight saving of the rotor R and the imbalance problem can be solved.

Furthermore, since the groove 1b is formed on the surface of the shaft 1 opposed to one of the molded resin members 3, the adhesive force along the axial direction can be increased. This also increases the axial adhesive force between the permanent magnets 2 and the formed resin member 3.

A rotor of a micro-servomotor according to the present invention can be applied to, e.g., factory automation equipments such as machine tools, semiconductor production apparatuses or food production apparatuses, or precision instruments such as measuring instruments or medical devices since the rotor is free from strength problem and right in weight.

While the present invention may be embodied in many different forms, a number of illustrative embodiments are described herein with the understanding that the present disclosure is to be considered as providing examples of the principles of the invention and such examples are not intended to limit the invention to preferred embodiments described herein and/or illustrated herein.

While illustrative embodiments of the invention have been described herein, the present invention is not limited to the various preferred embodiments described herein, but includes any and all embodiments having equivalent elements, modifications, omissions, combinations (e.g., of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive. For example, in the present disclosure, the term “preferably” is non-exclusive and means “preferably, but not limited to.” In this disclosure and during the prosecution of this application, means-plus-function or step-plus-function limitations will only be employed where for a specific claim limitation all of the following conditions are present in that limitation: a) “means for” or “step for” is expressly recited; b) a corresponding function is expressly recited; and c) structure, material or acts that support that structure are not recited. In this disclosure and during the prosecution of this application, the terminology “present invention” or “invention” may be used as a reference to one or more aspect within the present disclosure. The language present invention or invention should not be improperly interpreted as an identification of criticality, should not be improperly interpreted as applying across all aspects or embodiments (i.e., it should be understood that the present invention has a number of aspects and embodiments), and should not be improperly interpreted as limiting the scope of the application or claims. In this disclosure and during the prosecution of this application, the terminology “embodiment” can be used to describe any aspect, feature, process or step, any combination thereof, and/or any portion thereof, etc. In some examples, various embodiments may include overlapping features. In this disclosure and during the prosecution of this case, the following abbreviated terminology may be employed: “e.g.” which means “for example;” and “NB” which means “note well.”

We claim:

1. A rotor for a micro-servomotor a stator provided with a stator coil for forming rotating magnetic field and a rotor comprising a plurality of circular arc shaped permanent magnets attached to an external peripheral surface of a shaft so as to be opposed to the stator via a magnetic gap,
wherein the rotor further comprises molded resin members formed at both sides of the permanent magnets, each of the molded resin members having an inclined surface formed by filling resin material between an axial end face of the permanent magnets and the external peripheral surface of the shaft.

2. The rotor for a micro-servomotor according to claim 1, wherein the shaft is provided with a groove at a part of the external peripheral surface opposed to one of the formed resin members.

3. The rotor for a micro-servomotor according to claim 1, wherein the molded resin member covers at least edge portions of the axial end faces of the permanent magnets.

4. The rotor for a micro-servomotor according to claim 2, wherein the molded resin member covers at least edge portions of the axial end faces of the permanent magnets.

5. The rotor for a micro-servomotor according to claim 1, wherein the molded resin member covers entire surfaces of the permanent magnets.

6. The rotor for a micro-servomotor according to claim 2, wherein the molded resin member covers entire surfaces of the permanent magnets.

7. The rotor for a micro-servomotor according to claim 1, wherein the resin material is epoxy series resin material.

8. The rotor for a micro-servomotor according to claim 2, wherein the resin material is epoxy series resin material.

9. The rotor for a micro-servomotor according to claim 1, wherein the shaft has a stepped portion, and wherein the permanent magnets are axially positioned on the shaft with the permanent magnets fitted to the stepped portion.

10. The rotor for a micro-servomotor according to in claim 2, wherein the shaft has a stepped portion, and wherein the permanent magnets are axially positioned on the shaft with the permanent magnets fitted to the stepped portion.

11. The rotor for a micro-servomotor according to claim 9, wherein an external diameter of the stepped portion is smaller than an external diameter of the permanent magnet.

12. The rotor for a micro-servomotor according to claim 10, wherein an external diameter of the stepped portion is smaller than an external diameter of the permanent magnet.

13. A micro-servomotor equipped with the rotor as recited in claim 1.

14. The micro-servomotor according to claim 13, wherein the shaft is provided with a groove at a part of the external peripheral surface opposed to one of the formed resin members.

15. The micro-servomotor according to claim 13, wherein the molded resin member covers at least edge portions of the axial end faces of the permanent magnets.

16. The micro-servomotor according to claim 13, wherein the molded resin member covers entire surfaces of the permanent magnets.

17. The micro-servomotor according to claim 13, wherein the resin material is epoxy series resin material.

18. The micro-servomotor according to claim 13, wherein the shaft has a stepped portion, and wherein the permanent magnets are axially positioned on the shaft with the permanent magnets fitted to the stepped portion.

19. The micro-servomotor according to claim 13, wherein an external diameter of the stepped portion is smaller than an external diameter of the permanent magnet.
